(19) United States
(12) Patent Application Publication
(10) Pub. No.: US 2013/0076570 A1
(43) Pub. Date: Mar. 28, 2013

(54) RF MODULE

(71) Applicants: Jung Aun LEE, Suwon (KR); Myeong Woo Han, Hwaseong (KR); Dong Woon Chang, Hwaseong (KR); Joun Sup Park, Suwon (KR); Chan Yong Jeong, Seoul (KR)

(72) Inventors: Jung Aun LEE, Suwon (KR); Myeong Woo Han, Hwaseong (KR); Dong Woon Chang, Hwaseong (KR); Joun Sup Park, Suwon (KR); Chan Yong Jeong, Seoul (KR)

(73) Assignee: SAMSUNG ELECTRO-MECHANICS CO., LTD.

(21) Appl. No.: 13/334,966

(22) Filed: Dec. 22, 2011

(30) Foreign Application Priority Data
Sep. 26, 2011 (KR) 10-2011-0096745

(51) Int. Cl. H01Q 1/38

(52) U.S. Cl. 343/700 MS

(57) ABSTRACT

There is provided an RF module performing radio communications and allowing for a significantly reduced distance between an antenna and a semiconductor chip. To this end, the RF module includes a semiconductor chip; and a substrate including an anntenna unit formed by a circuit pattern thereon, and having a surface on which the semiconductor chip is mounted to be electrically connected to the antenna unit.

### CROSS-REFERENCE TO RELATED APPLICATIONS

This application claims the priority of Korean Patent Application No. 10-2011-0096745 filed on Sep. 26, 2011, In the Korean Intellectual Property Office, the disclosure of which is incorporated herein by reference.

### BACKGROUND OF THE INVENTION

1. Field of the Invention

The present invention relates to an RF module that performs a radio communications, and more particularly, to an RF module having a significantly reduced distance between an antenna and a semiconductor chip.

2. Description of the Related Art

As frequency sources for next-generation information communications services, the millimeter-wave band frequency, that is, microwave frequency resources of 30 GHz or above, has been actively scrutinized.

The frequencies in this band are able to transmit a large amounts of information at a high speed using broadband characteristics, have small interference in areas adjacent to the band due to large radio wave attenuation in the air, and do not have complexity in frequency usage channels as currently unused freqeuncy bands, unlike existing frequency bands such as 2.5 GHz, 5 GHz, and the like , and thereby have been the focus of research development and commercial aspects.

Accordingly, the development of information communications services and systems using millimeter-wave frequencies, and research and development of components for various devices required therefor has been undertaken.

In the milimeter-wave band, an electrical connection distance between an antenna and a semiconductor chip may be significantly important. That is, since loss increases in accordance with an increase in the distance between the antenna and the semiconductor chip, the antenna of the milimeter-wave band (particularly, for the 60 GHz band), may be electrically and closely connected to the semiconductor chip.

To this end, in the related art, the antenna is disposed at a location significantly close to a semiconductor package in which a semiconductor chip is mounted, and the antenna and the semiconductor package are electrically connected at the shortest possible distance.

In this RF module in the related art, the semiconductor package and the antenna are mounted on a substrate after being separately manufactured, to be electrically connected, so that there may be a disadvantage in that the manufacturing process thereof may be complex.

Also, an antenna power feed structure may be complex, such that the manufacturing process is complex, and analyzing effects on process errors may be difficult.

Therefore, there is a demand for an RF module structure in which a distance between the antenna and the semiconductor chip is reduced.

### SUMMARY OF THE INVENTION

An aspect of the present invention provides a semiconductor package having a significantly reduced electrical distance between an antenna and a semiconductor chip, while allowing for easy manufacturing thereof.

According to an aspect of the present invention, there is provided an RF module, including: a semiconductor chip; and a substrate including an anntenna unit formed by a circuit pattern thereon, and having a surface on which the semiconductor chip is mounted to be electrically connected to the antenna unit.

The antenna unit may transmit and receive a high frequency in a millimeter wave band.

The semiconductor chip may be mounted on the substrate through a flip-chip bonding method.

The antenna unit may be formed on one of both surfaces of the substrate.

The semiconductor chip may be mounted on the surface on which the antenna unit is formed.

The semiconductor chip may be mounted on a surface opposite to the surface on which the antenna unit is formed, and may be electrically connected with the antenna unit by a conductive via disposed in the substrate.

The antenna unit may include a power feed line and a radiator connected to an end of the power feed line, and the semiconductor chip maybe electrically connected with the other end of the power feed line.

The radiator may be a patch radiator.

The radiator may be a dielectric resonator formed in the substrate.

The dielectric resonator may include a plurality of metal vias forming a vertical metal boundary surface in the substrate; and a conductive plate formed inside the substrate or on a lower surface of the substrate, and electrically connected with the metal vias to form a horizontal metal boundary surface.

The end of the power feed line may be disposed so as to be inserted into the dielectric resonator.

The power feed line may include at least one matching pattern formed to be protruded outwardly from a position adjacent to the other end of the power feed line, and used for matching between the radiator and the semiconductor chip.

The matching pattern may be protruded in such a manner as to form a “+”-shape with the power feed line, while intersecting the power feed line.

The RF module may further include a plurality of metal vias disposed in a circumference of a bonding pad formed on the other end of the power feed line.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of an RF module according to an embodiment of the present invention;

FIG. 2 is a cross-sectional view of the RF module of FIG. 1, taken along line A-A′;

FIG. 3 is an exploded perspective view of the RF module of FIG. 1;

FIG. 4 is a schematic exploded perspective view of an RF module according to another embodiment of the present invention;

FIG. 5 is a schematic perspective view of an RF module according to another embodiment of the present invention;

FIG. 6 is a partially cross-sectional view taken along line B-B′ of FIG. 5; and

FIG. 7 is an exploded perspective view of an RF module according to another embodiment of the present invention.

### DETAILED DESCRIPTION OF THE INVENTION

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention. Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

Hereinafter, embodiments of the present invention will be described in detail with reference to the accompanying drawings. At this time, it is noted that like reference numerals denote like elements in appreciating the drawings. Moreover, detailed descriptions related to well-known functions or configurations will be ruled out in order not to unnecessarily obscure the subject matter of the present invention. Based on the same reason, it is to be noted that some components shown in the drawings are exaggerated, omitted or schematically illustrated, and the size of each component does not exactly reflect its real size.

Hereinafter, embodiments of the present invention will be described in detail with reference to the accompanying drawings.

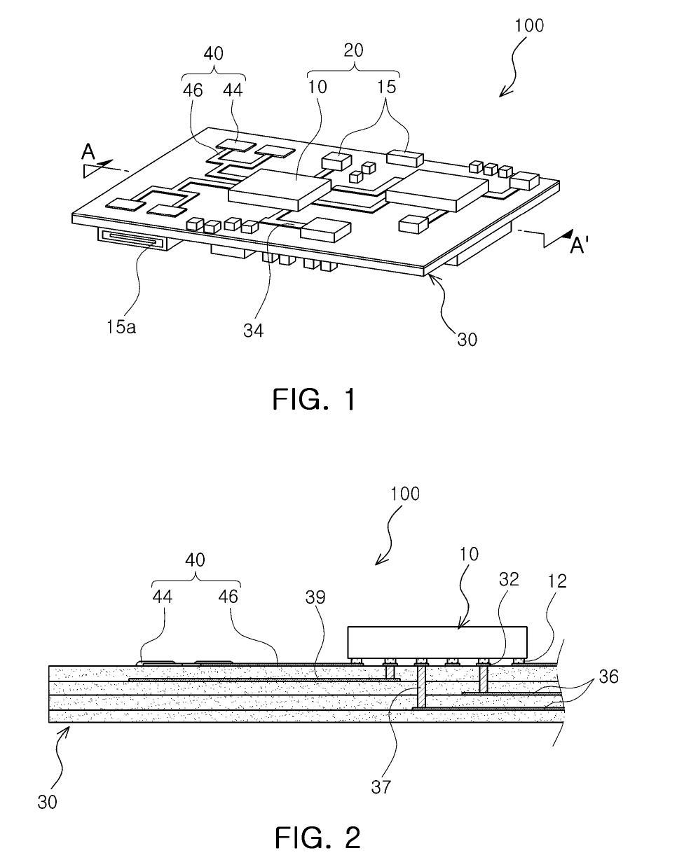

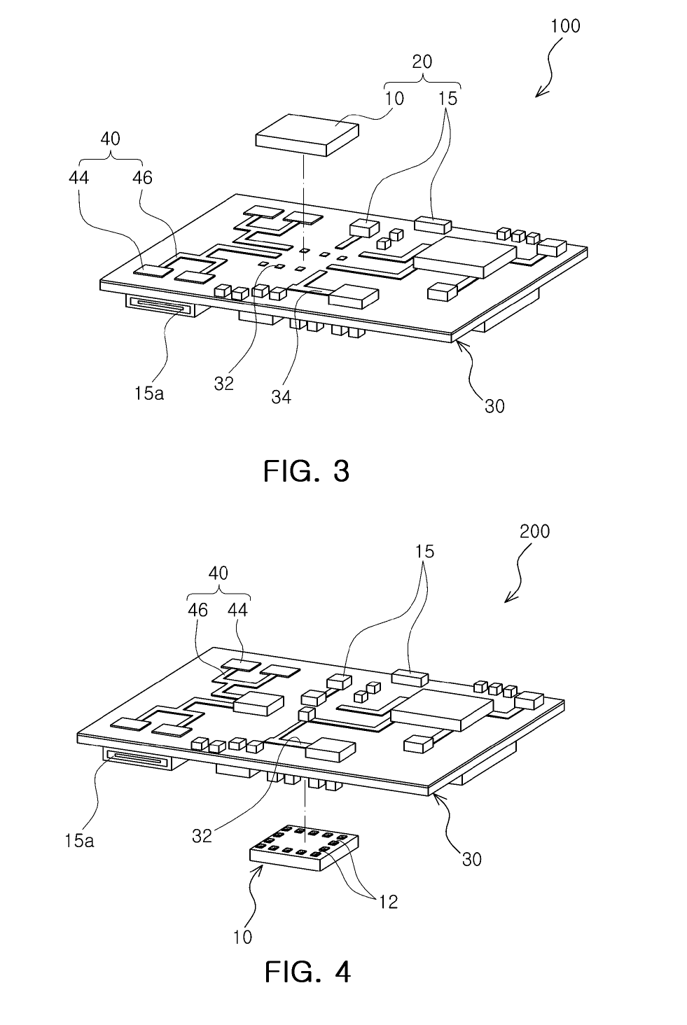

FIG. 1 is a schematic perspective view of an RF module according to an embodiment of the present invention. FIG. 2 is a cross-sectional view of the RF module of FIG. 1, taken along line A-A′. FIG. 3 is an exploded perspective view of the RF module of FIG. 1.

Referring to FIGS. 1 through 3, an RF module 100 according to the present embodiment may include a substrate 30 and a semiconductor chip 10.

The semiconductor chip 10 may include a plurality of connection pads 12 for connection with the outside, and may be electrically connected with the substrate 30, which will be described later, through the connection pad 12.

The semiconductor chip 10 according to the present embodiment may be mounted on the substrate 30 by a flip chip bonding method to be electrically connected with the substrate 30. However, the present invention is not limited thereto, and the semiconductor chip 10 may be electrically connected with the substrate 30 through various methods, such as a bonding wire method and the like, according to the shape of the semiconductor chip 10 and necessity.

The semiconductor chip 10 may perform radio communications with the outside through an antenna unit 40 which will be described later.

The semiconductor chip 10 may be fixed to and mounted on one surface of the substrate 30 and electrically connected with the substrate 30. As the substrate 30, a various kinds of substrate, for example, a silicon substrate, a ceramic substrate, a printed circuit board (PCB), a flexible substrate, or the like, which is well-known in the related art maybe used.

Electrode patterns 32 for electrical connection with the semiconductor chip 10 may be formed on one surface of the substrate 30. In addition, a circuit pattern 34 for electrically connecting the electrode patterns 32 with each other may be formed.

The substrate 30 according to the embodiment may be a multilayer substrate including a plurality of layers formed therein. Accordingly, between the respective layers, wiring patterns 36 for forming electrical connection therebetween, and a conductive via 37 for electrically connecting the respective layers may be formed.

A variety of electronic components 20 may be mounted on both surfaces of the substrate 30. For example, a connector 15a for electrically connecting the substrate to the outside (for example, a main substrate, and the like), an external electrode (not illustrated), and the like may be formed, and in addition to these, active and passive elements 15 for driving the RF module 100 may be mounted on the substrate 30.

In addition, the antenna unit 40 may be formed on at least one of the both surfaces of the substrate 30 according to the embodiment of the present invention.

The antenna unit 40 may be disposed on the substrate 30 to be electrically connected with the semiconductor chip 10.

The antenna unit 40 may be formed on one surface of the substrate 30 in the form of the circuit pattern. Accordingly, the antenna unit 40 according to the embodiment of the present invention may be formed together with the circuit pattern 34 at the time of forming the circuit pattern 34 on the substrate 30, in the process of manufacturing the substrate 30. Accordingly, a separate process of manufacturing the antenna unit 40 may not be required.

The antenna unit 40 may include a radiator 44 and a power feed line 46. The radiator 44 may substantially radiate radio waves to the outside. Meanwhile, in the embodiment of the present invention, the radiator 44 of the antenna unit 40 is formed to have a rectangular patch shape. However, the present invention is not limited thereto.

The power feed line 46 may have one end connected with the radiator 44, and the other end connected with the connection pad 12 of the semiconductor chip 10, so that a high frequency signal applied from the semiconductor chip 10 maybe transmitted to the radiator 44.

Meanwhile, a ground electrode 39 may be formed inside the substrate 30 or on a lower surface of the substrate 30 in such a manner as to correspond to the power feed line 46 or the radiator 44.

In the antenna unit 40 according to the embodiment, the power feed line 46 may be directly electrically connected to the connection pad 12 of the semiconductor chip 10.

Accordingly, a distance between the semiconductor chip 10 and the antenna unit 40 may be significantly reduced, as compared to an RF module according to the related art, formed by electrically connecting a semiconductor package in which the semiconductor chip 10 is packaged using a molding member or the like, and a separately manufactured antenna module to each other.

Thus, a radiation loss generated due to a connection distance between the semiconductor chip 10 and the radiator 44 may be significantly reduced.

In addition, in the antenna unit 40, the radiator 44 may be provided in plural, and antenna characteristics, such as a radiation direction, a gain, or the like may be improved by changing a position of the power feed line 46 connected with the semiconductor chip 10, or the number, a size, a shape, or the like of the radiators 44. In this case, distances between the plurality of radiators 44, and a position, a size, and a shape of the power feed line 46 of each of the radiators 44 may be used as design variables of the RF module.

A method of manufacturing the RF module according to the embodiment of the present invention, as configured above, will be described as follows.

As for the RF module according to the embodiment, a process of preparing the semiconductor chip 10 may be first performed. As illustrated in FIG. 2, the semiconductor chip 10 according to the embodiment of the present invention may be manufactured in a flip-chip form.

Next, a process of preparing the substrate 30 may be performed. The substrate 30 may be a multilayer substrate, and the antenna unit 40 may be formed on at least one surface of the substrate 30. As described above, the antenna unit 40 may be formed together with the circuit pattern 34 at the time of forming the circuit pattern 34 on the substrate 30, in the process of manufacturing the substrate 30.

Next, a process of mounting the variety of electronic components 20 including the semiconductor chip 10 on the substrate 30 maybe performed, thereby completing the RF module according to the embodiment illustrated in FIG. 1.

In the method of manufacturing the RF module according to the embodiment, the RF module 100 according to the embodiment may be completed by only mounting the semiconductor chip 10 on the substrate 30 after separately preparing the semiconductor chip 10 and the substrate 30.

Accordingly, a separate substrate only for an antenna may not required to manufacture the antenna unit 40 as in the related art, whereby a manufacturing costs and a manufacturing time may be reduced.

In addition, in the RF module according to the embodiment, the antenna unit 40 is formed on the substrate 30 in the form of the circuit pattern, and the semiconductor chip 10 is directly mounted on the substrate 30, so that an electrical distance between the antenna unit 40 and the semiconductor chip 10 may be significantly reduced.

Accordingly, the RF module 100 according to the embodiment may obtain more excellent effects in the millimeter-wave (mm Wave) band, particularly, in the 60 GHz band in which a characteristic degradation is significantly shown according to the distance between the semiconductor chip 10 and the antenna.

That is, the RF module 100 according to the embodiment may have an optimized configuration for transmitting and receiving high frequencies of the millimeter-wave band (particularly, the 60 GHz band), so that loss generated between the antenna unit 40 and the semiconductor chip 10 when the RF module 100 according to the embodiment is used in the millimeter-wave band may be significantly reduced.

In addition, in the RF module 100 according to the embodiment of the present invention, since the antenna unit 40 is formed on the substrate 30 in the form of the circuit pattern, the antenna unit 40 may be formed together with the circuit pattern 34 at the time of forming the circuit pattern 34 in the process of manufacturing the substrate 30, without separately manufacturing the antenna unit 40.

Meanwhile, the RF module according to the embodiment of the present invention is not limited to the foregoing embodiment, and various applications thereof may be possible. An RF module according to the following embodiments may have a similar structure as that of the RF module (100 of FIG. 1) according to the embodiment, but may be different only in terms of a mounting structure of the semiconductor chip or a structure of the antenna unit. Accordingly, detailed descriptions of the same components will be omitted, and the mounting structure of the semiconductor chip or the structure of the antenna unit will be mainly described in more detail. In addition, the same components as those of the foregoing embodiment will be described using the same reference numerals.

FIG. 4 is a schematic exploded perspective view of an RF module according to another embodiment of the present invention.

An RF module 200 according to the embodiment may have a similar configuration to that of the RF module (100 of FIG. 1) according to the foregoing embodiment, and may be different only in terms of a mounting position of the semiconductor chip 10.

That is, the RF module 200 according to the embodiment may be configured such that the antenna unit 40 and the semiconductor chip 10 are disposed on different surfaces of the substrate 30. In this case, the power feed line 46 of the antenna unit 40 may include a conductive via (not illustrated) penetrating the substrate 30, and the connection pad 12 of the semiconductor chip 10 may be electrically connected with the conductive via.

In addition, in FIG. 4, the semiconductor chip 10 is mounted in a position of a lower surface of the substrate 30, the position being spaced apart from the radiator 44 of the antenna unit 40 by a predetermined distance (a horizontal distance); however, the present invention is not limited thereto. The semiconductor chip 10 may be mounted on the lower surface of the substrate 30, corresponding to the radiator 44 of the antenna. In this case, the entire length of the power feed line 46 may be more reduced.

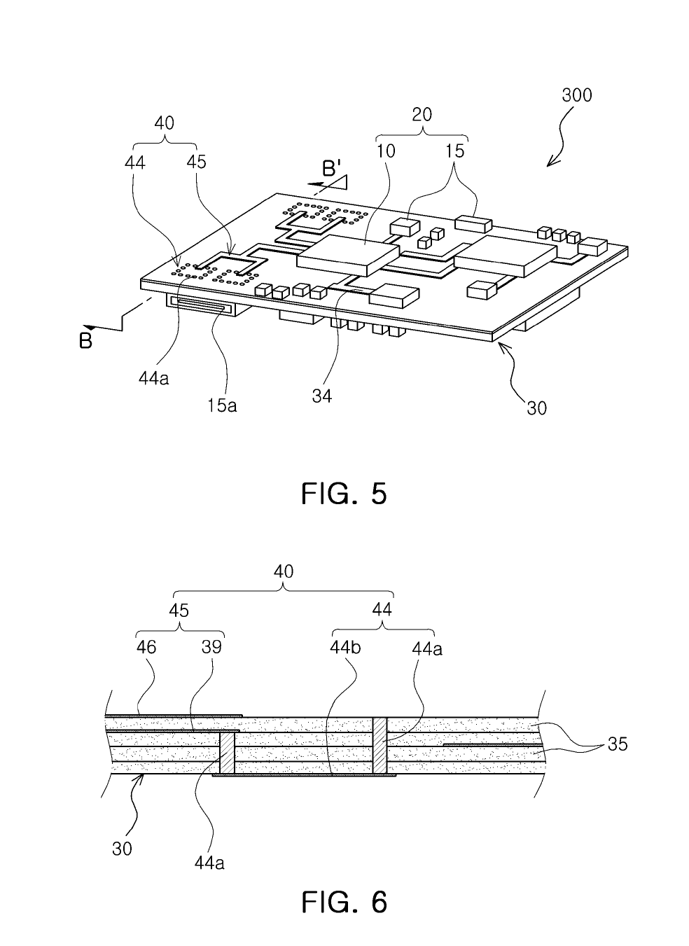

FIG. 5 is a schematic perspective view of an RF module according to another embodiment of the present invention. FIG. 6 is a partially cross-sectional view taken along line B-B′ of FIG. 5.

Referring to FIGS. 5 and 6, an RF module 300 according to the embodiment may have a similar configuration to that of the RF module of FIG. 1, and may be different only in terms of the structure of the antenna unit 40.

The antenna unit 40 of the RF module 300 according to the embodiment of the present invention may be a dielectric resonator antenna (DRA). The dielectric resonator antenna provided as the antenna unit 40 may be used to increase efficiency of the antenna and secure a wide bandwidth, and the like.

The antenna unit 40, the dielectric resonator antenna, according to the embodiment may be formed together with the circuit pattern in the process of manufacturing the substrate 30, in a similar manner as that of the foregoing embodiment.

The antenna unit 40, the dielectric resonator antenna, may include a dielectric resonator 44 and a power feed unit 45.

The dielectric resonator 44 may maintain a resonant mode using a vertical metal boundary surface disposed in a vertical direction of the substrate 30, and a horizontal metal boundary surface formed by a conductive plate 44b formed on the lower surface of the substrate 30.

In this case, the vertical metal boundary surface of the substrate 30 maybe ideally in the form of a plane; however, due to difficulties in manufacturing thereof, a plurality of metal vias 44a arranged at regular intervals maybe used instead of using the vertical metal boundary surface.

Accordingly, the substrate 30 according to the embodiment may include the plurality of metal vias 44a vertically penetrating the substrate 30 to form the vertical metal boundary surface, in order to mount the dielectric resonator 44 therein.

Therefore, the dielectric resonator 44 in the form of a cavity having an opened upper surface due to the conductive plate 44b and the metal vias 44a maybe mounted in the substrate 30.

The dielectric resonator 44 mounted in the substrate 30 may have a hexahedral shape or a cylinderical shape; however, the present invention is not limited thereto. That is, the dielectric resonator 44 may be manufactured to have any shape.

The power feed unit 45 may be formed at a side of the dielectric resonator 44 so as to feed power to the dielectric resonator 44 mounted in the substrate 30.

The power feed unit 45 may be formed in the form of transmission lines such as a strip line, a micro-strip line, and a CPW (coplanar waveguide) line, which are easily formed on the substrate 30.

The power feed unit 45 may include a single power feed line 46 and at least one ground line 39. FIG. 5 exemplarily illustrates that the power feed unit 45 is realized to have a micro-strip structure.

The power feed unit 45 having the micro-strip structure maybe disposed horizontally to the opened upper surface of the dielectric resonator 44, and include the power feed line 46 formed of a line shaped-metallic plate extended so as to be inserted into the dielectric resonator 44 from a side of the dielectric resonator 44. In this case, an end of the power feed line 46 maybe basically formed to have a straight line; however, the present invention is not limited thereto. That is, the end of the power feed line 46 may be variously formed, such as a polygonal shape, a circular shape, or the like, as necessary.

In addition, the power feed unit 45 may be positioned to correspond to the power feed line 46, and include the ground line 39 formed on a lower surface of an insulating layer 35 in which at least one layer is stacked from the power feed line 46. The ground line 39 may be formed to have a plate shape, and electrically connected with the metal via 44a.

A high-frequency signal may be applied to the dielectric resonator 44 mounted in the substrate 30 configured as above through the power feed line 46 of the power feed unit 45, and the dielectric resonator 44 may act as an antenna radiator that radiates a high frequency signal resonating in a specific frequency through an opening according to a shape and a size of the dielectric resonator 44.

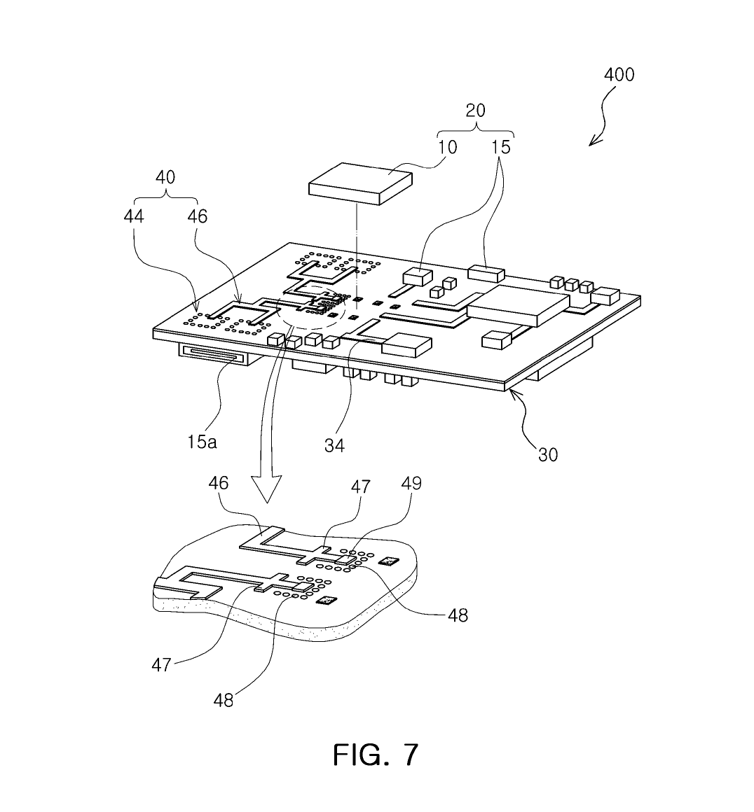

FIG. 7 is an exploded perspective view of an RF module according to another embodiment of the present invention.

Referring to FIG. 7, an RF module 400 according to the embodiment maybe configured in a similar manner as that of the the RF module according to the foregoing embodiment illustrated in FIG. 1 or FIG. 5, and may be different only in terms of a structure of the power feed line 46 of the antenna unit 40.

The end of the power feed line 46 according to the embodiment, on which the semiconductor chip 10 is mounted, may have at least one matching pattern 47 formed therein.

The matching pattern 47 may be provided such that the semiconductor chip 10 and the antenna unit 40 are matched to each other. That is, characteristics of the antenna, such as a radiation direction, a gain, and the like may be improved by controlling a shape, a size, and the like of the matching pattern 47.

In the case of the embodiment, the matching pattern 47 may be protruded in such a manner as to form a “+”-shape with the power feed line 46, while intersecting the power feed line 46. However, the present invention is not limited thereto.

On the end of the power feed line 46 according to the embodiment, which is electrically connected with the semiconductor chip 10, a bonding pad 49 may be formed. The plurality of metal vias 48 may be disposed in the circumference of the bonding pad 49. The metal vias 48 may be used to match the semiconductor chip 10 and the antenna unit 40 together with the matching pattern 47.

As described above, the RF module according to the embodiments of the present invention may be variously formed according to a mounting position of the semiconductor chip or a shape of the radiator.

In particular, as described above, in the RF module according to the embodiments of the present invention, the shape and the number of radiators, a matching pattern, or the like maybe controlled so as to improve antenna characteristics, so that the radiation pattern and gain of an antenna maybe easily controlled at the time of manufacturing thereof.

Meanwhile, the RF module according to the present invention is not limited to the above described embodiments, and various applications thereof will be possible.

In addition, the foregoing embodiments exemplarily illustrate the semiconductor chip mounted on the substrate; however, the present invention is not limited thereto. The RF module may be applied in various ways as long as the RF module may allow for the semiconductor chip to be mounted on the substrate, such as mounting the semiconductor chip in the cavity after forming the cavity in the substrate, and the like.

As set forth above, according to the embodiments of the present invention, the RF module according to the embodiments of the present invention may be completed by only mounting the semiconductor chip on the substrate after separately preparing the semiconductor chip and the substrate. In particular, the antenna unit according to the embodiments of the present invention may be formed on the substrate in the form of the circuit pattern, so that the antenna unit maybe formed together with the circuit pattern at the time of forming the circuit pattern in the process of manufacturing the substrate, without separately manufacturing the antenna unit.

Accordingly, in order to manufacture the antenna unit in the related art, a separate substrate only for an antenna may not be required to be used, so that a manufacturing cost and a manufacturing time may be reduced.

In addition, as for the RF module according to the embodiments of the present invention, the antenna unit may be formed on the substrate in the form of the circuit pattern, and the semiconductor chip may be directly mounted on the substrate, so that an electrical distance between the antenna unit and the semiconductor chip may be significantly reduced.

Accordingly, when the RF module according to the embodiments of the present invention is used in the millimeter band (particularly, for the 60 GHz band), loss generated between the antenna unit and the semiconductor chip may be significantly reduced.

While the present invention has been shown and described in connection with the embodiments, it will be apparent to those skilled in the art that modifications and variations can be made without departing from the spirit and scope of the invention as defined by the appended claims.

What is claimed is:

1. An RF module, comprising:
a semiconductor chip; and
a substrate including an anntenna unit formed by a circuit pattern thereon, and having a surface on which the semiconductor chip is mounted to be electrically connected to the antenna unit.

2. The RF module of claim 1, wherein the antenna unit transmits and receives a high frequency in a millimeter wave band.

3. The RF module of claim 1, wherein the semiconductor chip is mounted on the substrate through a flip-chip bonding method.

4. The RF module of claim 1, wherein the antenna unit is formed on one of both surfaces of the substrate.

5. The RF module of claim 4, wherein the semiconductor chip is mounted on the surface on which the antenna unit is formed.

6. The RF module of claim 4, wherein the semiconductor chip is mounted on a surface opposite to the surface on which the antenna unit is formed, and is electrically connected with the antenna unit by a conductive via disposed in the substrate.

7. The RF module of claim 1, wherein the antenna unit includes a power feed line and a radiator connected to an end of the power feed line, and the semiconductor chip is electrically connected with the other end of the power feed line.

8. The RF module of claim 7, wherein the radiator is a patch radiator.

9. The RF module of claim 7, wherein the radiator is a dielectric resonator formed in the substrate.

10. The RF module of claim 9, wherein the dielectric resonator includes:
a plurality of metal vias forming a vertical metal boundary surface in the substrate; and
a conductive plate formed inside the substrate or on a lower surface of the substrate, and electrically connected with the metal vias to form a horizontal metal boundary surface.

11. The RF module of claim 10, wherein the end of the power feed line is disposed so as to be inserted into the dielectric resonator.

12. The RF module of claim 7, wherein the power feed line includes at least one matching pattern formed to be protruded outwardly from a position adjacent to the other end of the power feed line, and used for matching between the radiator and the semiconductor chip.

13. The RF module of claim 12, wherein the matching pattern is protruded in such a manner as to form a “+”-shape with the power feed line, while intersecting the power feed line.

14. The RF module of claim 7, further comprising a plurality of metal vias disposed in a circumference of a bonding pad formed on the other end of the power feed line.
